(19) United States
(12) Patent Application Publication
(10) Pub. No.: US 2013/0162059 A1
(43) Pub. Date: Jun. 27, 2013

(54) ACTUATOR HAVING TWO-STAGE ZOOM FUNCTION

(71) Applicant: Hsiang-Chieh YU, Tu-Cheng (TW)

(72) Inventor: Hsiang-Chieh YU, Tu-Cheng (TW)

(73) Assignee: HON HAI PRECISION INDUSTRY CO., LTD., Tu-Cheng (TW)

(21) Appl. No.: 13/612,894

(22) Filed: Sep. 13, 2012

(30) Foreign Application Priority Data
Dec. 27, 2011 (TW) 100149022

(51) Int. Cl. H02K 41/035

(52) U.S. Cl. 310/12.16

(57) ABSTRACT

An actuator includes a bracket, permanent magnetic elements, a fixing barrel, and a movable unit. The actuator forms a central axis. The bracket includes a front frame and a rear frame connected with the front frame. Both the front frame and the rear frame include a supporting plate. Each supporting plate defines a through hole coaxial with the central axis. The permanent magnetic elements are positioned on supporting plates of the front and rear frames and surround through holes of the front and rear frames. The movable unit includes a hollow core member and a coil group wrapping around the core member. A height of the core member is smaller than that of the fixing barrel. The core member is movably received in the fixing barrel. The fixing barrel is housed in the bracket, and is sandwiched between the permanent magnetic elements.

### BACKGROUND

1. Technical Field

The present disclosure relates to the optical imaging field and, particularly, to an actuator having two-stage zoom function.

2. Description of Related Art

With the development of the optical imaging technology, camera modules are widely used in a variety of electronic devices, such as mobile phones, and Personal Digital Assistants (PDAs).

For example, third generation (3G) mobile phones include camera modules. The camera modules use actuators to provide zoom and auto-focus functions, and the actuators can, for example, be stepper motors. It is frequently necessary to use a gear assembly to transform the rotational movement of the actuator into linear movement. However, such gear assembly generally increases the bulk of the camera module. Furthermore, the occurrence of backlash or recoil in the gear assembly may degrade the focus accuracy.

Therefore, it is desirable to provide an actuator which can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an assembled, isometric view of an actuator, according to an exemplary embodiment.

FIG. 2 is an exploded view of the actuator of FIG. 1.

FIG. 3 shows the exploded actuator of FIG. 2, but viewed from another angle.

### DETAILED DESCRIPTION

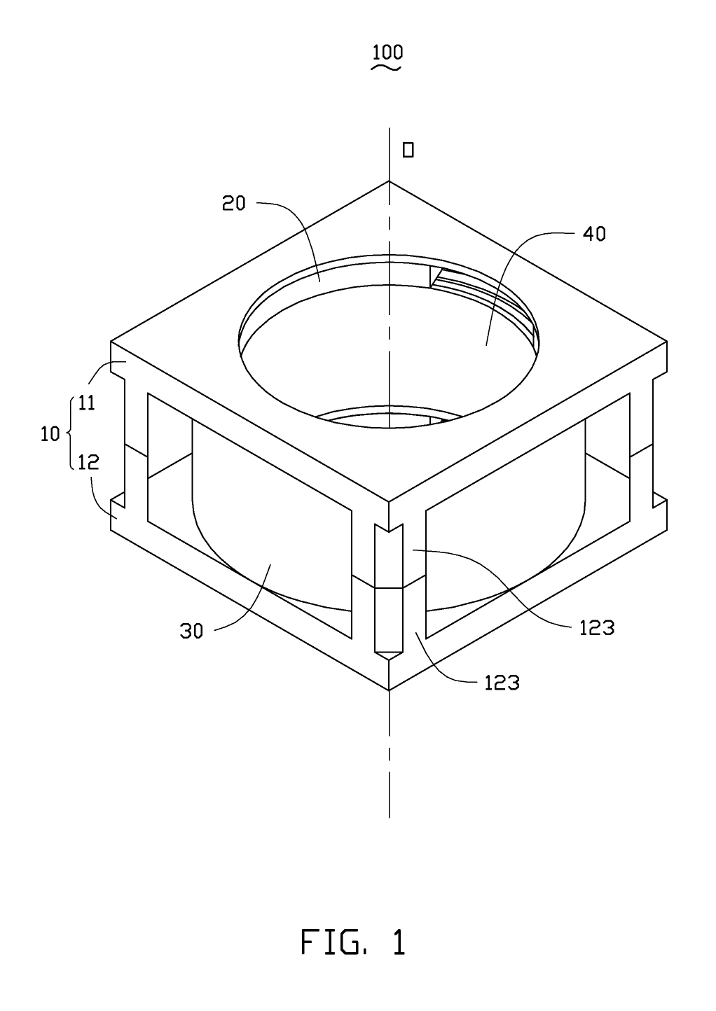

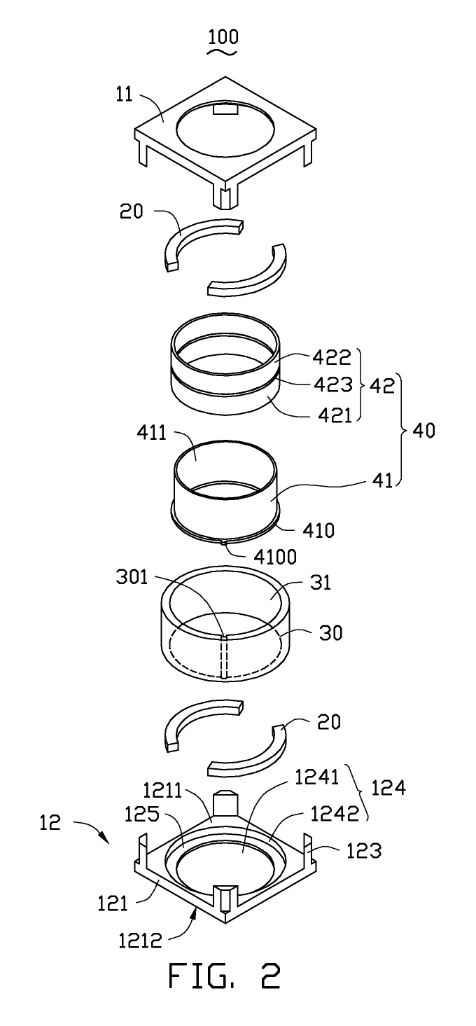

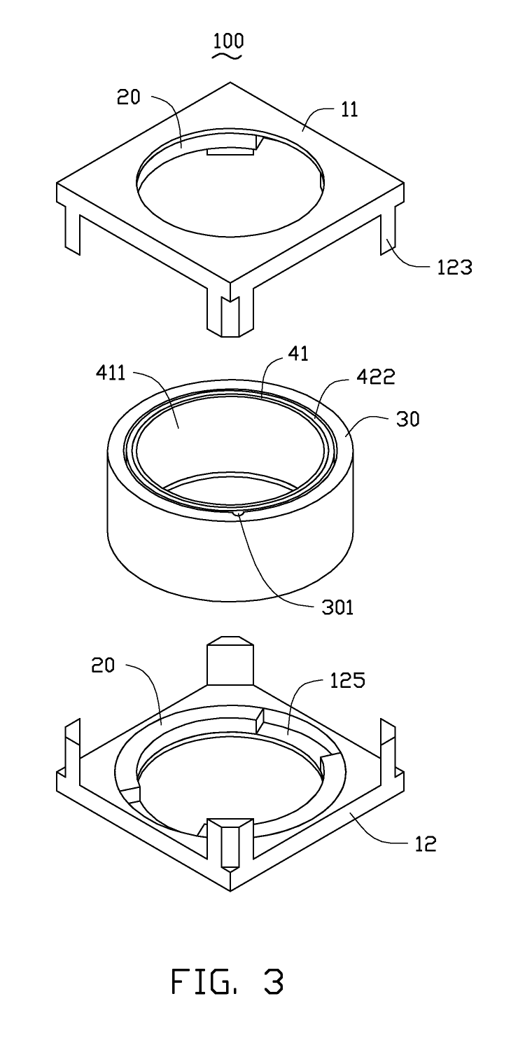

Referring to FIGS. 1-3, an actuator 100 according to an exemplary embodiment is shown. The actuator 100 includes a bracket 10, a number of permanent magnetic elements 20, a fixing barrel 30, and a movable unit 40. The movable unit 40 is wrapped around and received in the fixing barrel 30. The fixing barrel 30 and the number of permanent magnetic elements 20 are received in the bracket 10. The actuator 100 forms a center axis O.

The bracket 10 is made of electrically conductive materials, such as a conductive alloy, a conductive polymer, or conductive glass, which provides electro EMI shielding for the actuator 100. In this embodiment, the bracket 10 is made of ferronickel alloy. The bracket 10 includes a front frame 11 and a rear frame 12 connected to the front frame 11. The front frame 11 and the rear frame 12 are coaxial with each other. The structure of the front frame 11 is substantially the same as the structure of the rear frame 12, so this disclosure only takes the structure of the rear frame 12 as an example.

The rear frame 12 includes a supporting plate 121. The supporting plate 121 is substantially cuboid, and includes a supporting surface 1211 and a bottom surface 1212 away from the supporting surface 1211. Four alignment poles 123 are integrally formed with and perpendicularly extend upward from the supporting surface 1211. Alternately, the four alignment poles 123 and the supporting plate 121 may be separately formed. The alignment poles 123 can be attached to the supporting surface 1211 by adhesive, welding (e.g., plastic welding), or other attaching methods. All of the alignment poles 123 have essentially identical height to promote even loading thereon. In the embodiment, the alignment poles 123 are respectively located on/at the four corners of the supporting surface 1211.

The supporting plate 121 defines a stepped hole 124 in a center of the supporting surface 1211. The stepped hole 124 includes a first through hole 1241 and a second through hole 1242. In the embodiment, both the first through hole 1241 and the second through hole 1242 are circular and coaxial with each other. A diameter of the first through hole 1241 is smaller than a diameter of the second through hole 1242, as such, a stepped surface 125 forms between the first through hole 1241 and the second through hole 1242.

In the embodiment, the number of permanent magnetic elements 20 is four. Each of the four permanent magnetic elements 20 is substantially in an arc shape. A diameter of the four permanent magnetic elements 20 is equal to the diameter of the first through hole 1241. Two permanent magnetic elements 20 are positioned on the stepped surface 125 of the rear frame 12 surrounding the first through hole 1241. The other two permanent magnetic elements 20 are positioned on the stepped surface 125 of the front frame 11. A thickness of an inner sidewall of the second through hole 1242 along the direction parallel to the center axis O of the actuator 100 is equal to that of the permanent magnetic elements 20. The polarities distribution of the four permanent magnetic elements 20 is the same. In the embodiment, one end of each permanent magnetic element 20 close to the center axis O of the actuator 100 is N polarity, and the other end of each permanent magnetic element 20 away from the center axis O is S polarity. In another embodiment, one end of each permanent magnetic element 20 close to the center axis O of the actuator 100 can be S polarity, while the other end of each permanent magnetic element 20 away from the center axis O can be N polarity.

In alternative embodiments, the number of the permanent magnetic elements 20 can have two, or more than four, which can be set based on requirements.

The fixing barrel 30 is made of yoke iron, and is a ring structure. An internal diameter of the fixing barrel 30 is slightly larger than the diameter of the first through hole 1241 and slightly smaller than the diameter of the second through hole 1242. An inner wall 31 of the fixing barrel 30 defines a guide slot 301 along the direction parallel to the center axis O of the actuator 100.

The movable unit 40 includes a hollow core member 41, and a coil group 42 wrapped around the core member 41. The core member 41 is made of plastic, and defines a circular receiving space 411 in its center. The receiving space 411 is configured for receiving a lens module (not shown), such that the lens module is held (fixed) in the core member 41. The shape of the receiving space 411 is substantially cylindrical.

A diameter of the receiving space 411 is equal to the diameter of the first through hole 1241, and smaller than the diameter of the second through hole 1242. A height of the core member 41 is smaller than a height of the fixing barrel 30 in the direction parallel to the center axis O of the actuator 100. A circular flange 410 perpendicularly extends from an end of the core member 41. A guide block 4100 perpendicularly extends from an external sidewall of the flange 410 in a radial direction of the circular flange 410. The guide block 4100 spatially corresponds to the guide slot 301.

The coil group 42 includes a rear coil 421, a front coil 422, and a spacer 423 sandwiched between the rear coil 421 and the front coil 422. The spacer 423 is also made of ferronickel alloy, which can increase electromagnetic strength.

In alternative embodiments, the spacer 423 can be omitted to reduce the cost of the actuator 100.

In assembly of the actuator 100, first, two of the four permanent magnetic elements 20 are positioned on the stepped surfaces 125 of the rear frame 12 through an adhesive (not shown), the other two permanent magnetic elements 20 are positioned on the stepped surfaces 125 of the front frame 11. Second, the coil group 42 is wrapped around the core member 41 and supported on the flange 410, the movable unit 40 is received in the fixing barrel 30, with the guide block 4100 being movably engaged in the guide slot 301. Then, the assembled fixing barrel 30 and the movable unit 40 are received in the rear frame 12, with the fixing barrel 30 being supported on the permanent magnetic elements 20. Finally, the rear frame 12 is connected to the front frame 11, with each of the four alignment poles 123 of the rear frame 12 being attached to a respective one of the alignment poles 123 of the front frame 11 by adhesive, welding (e.g., plastic welding), or other attaching methods. In the embodiment, an internal diameter of the fixing barrel 30 is slightly larger than the diameter of the first through hole 1241 and slightly smaller than the diameter of the second through hole 1242, such that the fixing barrel 30 is sandwiched between the four permanent magnetic elements 20 received in the front frame 11 and the rear frame 12. As such, assembly of the actuator 100 is completed.

In use of the actuator 100, when applying a first polarity current to the rear coil 421 and the front coil 422, magnetic driving forces between the permanent magnetic elements 20 and the rear and front coils 421, 422 are generated. The movable unit 40 is driven toward the front frame 11 in the direction parallel to the center axis O of the actuator 100. Therefore the lens module, which is held in the core member 41, is driven along with the movable unit 40 for achieving focusing and zooming functions, for example. The guide block 4100 moves along the guide of the guide slot 301, which is capable of preventing the lens module from being deviated from the center. When applying a second polarity current to the rear coil 421 and the front coil 422, magnetic driving forces between the permanent magnetic elements 20 and the rear and front coils 421, 422 are generated, and the movable unit 40 is driven toward the rear frame 12 in the direction parallel to the center axis O of the actuator 100, as such, the actuator 100 is capable of obtaining two-stage zoom function. In the embodiment, the second polarity current and the first polarity current are opposite to each other.

It will be understood that the above particular embodiments are shown and described by way of illustration only. The principles and the features of the present disclosure may be employed in various and numerous embodiments without departing from the scope of the disclosure. The above-described embodiments illustrate the scope of the disclosure but do not restrict the scope of the disclosure.

What is claimed is:

1. An actuator having a center axis, comprising:
a bracket comprising a front frame and a rear frame connected to and coaxial with the front frame, both the front frame and the rear frame comprising a supporting plate, each supporting plate defining a first through hole coaxial with the central axis;
a plurality of permanent magnetic elements positioned on two supporting plates of the front frame and the rear frame and surrounding first through holes of the two supporting plates, one end of each permanent magnetic element close to the center axis of the actuator being a first polarity, and the other end of each permanent magnetic element facing away from the center axis being a second polarity, the first and second polarities being opposite to each other;
a fixing barrel received in the bracket, an internal diameter of the fixing barrel being larger than a diameter of the first through holes, the fixing barrel sandwiched between the permanent magnetic elements positioned on the supporting plates of the front frame and the rear frame; and
a movable unit comprising a hollow core member and a coil group wrapping around the core member, a height of the core member being smaller than a height of the fixing barrel in a direction parallel to the center axis, the core member movably received in the fixing barrel.

2. The actuator of claim 1, wherein each of the supporting plates defines a stepped hole in a center of the supporting surface, the stepped hole comprises the first through hole and a second through hole, both the first through hole and the second through hole are circular and coaxial with each other, the diameter of the first through hole is smaller than a diameter of the second through hole, whereby a stepped surface forms between the first through hole and the second through hole, and the permanent magnetic elements are positioned on stepped surfaces of the supporting plates.

3. The actuator of claim 2, wherein the plurality of permanent magnetic elements comprises four permanent magnetic elements, two of the four permanent magnetic elements are positioned on the stepped surface of the rear frame and surround the first through hole of the rear frame, and the other two permanent magnetic elements are positioned on the stepped surface of the front frame and surround the first through hole of the front frame.

4. The actuator of claim 2, wherein each of the permanent magnetic elements is substantially in an arc shape, and a diameter of each permanent magnetic element is equal to the diameter of the first through hole.

5. The actuator of claim 2, wherein an internal diameter of the fixing barrel is slightly smaller than the diameter of the second through hole.

6. The actuator of claim 1, wherein the bracket is made of electrically conductive materials.

7. The actuator of claim 1, wherein each of the supporting plates comprises a supporting surface and four alignment poles perpendicularly extending upward from the supporting surface, each of the four alignment poles of one of the supporting plates are attached to a respective one of the alignment poles of the other supporting plate.

8. The actuator of claim 7, wherein all of the alignment poles have essentially identical height in the direction parallel to the center axis.

9. The actuator of claim 1, wherein the fixing barrel is made of yoke iron.

10. The actuator of claim 1, wherein the core member is made of plastic, and defines a circular receiving space in its center.

11. The actuator of claim 10, wherein the receiving space is substantially cylindrical-shaped, a diameter of the receiving space is substantially equal to the diameter of the first through holes.

12. The actuator of claim 10, wherein the core member comprises a circular flange perpendicularly extending from an end thereof, the flange comprises a guide block perpendicularly extending from its external sidewall in a radial direction of the flange, an inner wall of the fixing barrel defines a guide slot along the direction parallel to the center axis of the actuator, and the guide block spatially corresponds to the guide slot and is movably engaged in the guide slot.

13. The actuator of claim 1, wherein the coil group comprises a rear coil and a front coil connected to the rear coil.

14. The actuator of claim 1, wherein the coil group comprises a rear coil, a front coil, and a spacer, the spacer is sandwiched between the rear coil and the front coil.

15. The actuator of claim 14, wherein the spacer is made of ferronickel alloy.
